(19) United States
(12) Patent Application Publication
(10) Pub. No.: US 2010/0042615 A1
(43) Pub. Date: Feb. 18, 2010

(54) SYSTEMS AND METHODS FOR AGGREGATING CONTENT ON A USER-CONTENT DRIVEN WEBSITE

(76) Inventor: Peter Rinearson, Vashon, WA (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/539,789

(22) Filed: Aug. 12, 2009

Related U.S. Application Data
(60) Provisional application No. 61/088,311, filed on Aug. 12, 2008.

(51) Int. Cl. G06F 7/10; G06F 17/30

(52) U.S. Cl. 707/5; 707/E17.014; 707/3

(57) ABSTRACT

One or more items submitted by user-contributors of a website may be aggregated according to aggregation criteria. The aggregation criteria may specify a topic or type of item to be included in the aggregation. The aggregation criteria may be generated a priori by a user of the website and/or may be generated on-the-fly based on a search, inbound link, or the like. User contributed items may be associated with metadata and/or tags. The items and, importantly the metadata associated therewith, may be rated by users of the website. The item ratings, the metadata, and/or the metadata ratings may be used to aggregate relevant items, thereby increasing the probability that the aggregation closely matches the aggregation criteria. The aggregated items may be presented in a user interface to one or more users of the website.

### CROSS-REFERENCE TO RELATED APPLICATIONS

This application claims the benefit of U.S. Provisional Application No. 61/088,311, filed Aug. 12, 2008, which is fully incorporated here by reference.

### TECHNICAL FIELD

This disclosure relates to systems and methods for aggregating user-submitted content using metadata and/or tags associated with the content.

### BRIEF DESCRIPTION OF THE DRAWINGS

FIG. 1 depicts one embodiment of a content submission interface;

FIG. 2 depicts one embodiment of a content presentation and rating interface;

FIG. 3 is a flow diagram of a method for aggregating user-submitted content;

FIG. depicts 4 is one embodiment of an interface for presenting aggregated user-submitted content;

FIG. 5 depicts one embodiment of an interface for presenting aggregated user-submitted content; and

FIG. 6 depicts a system for generating, storing, and presenting aggregated content to one or more user-computing devices over a network.

### DETAILED DESCRIPTION OF PREFERRED EMBODIMENTS

Websites featuring user-contributed content have become very popular and are among the fastest growing websites on the Internet. Many of these websites allow users to rate the content presented thereon. In some cases, metadata may be associated with the user-submitted content. The metadata may include a title of the content, a caption associated with the content, a description of the creation and/or authoring of the content, one or more tags associated with the content, or the like.

A website may allow other users to rate the content submitted to the site. The rating of a particular content item, may determine what content items are featured on the site. Content that is highly rated may be prominently displayed and/or highlighted on the site. The systems and methods disclosed herein may also provide for rating metadata associated with content. The ratings of the metadata may be used to determine whether a particular item is related to a particular topic, area of interest, or the like.

As used herein, a website may refer to a collection of renderable content comprising images, videos, audio, text, location data (e.g., location coordinates, route information, or the like), interactive content (e.g., Flash® content), or other digital assets that are accessible by a plurality of users over a network. A website may be published on the Internet, a local area network (LAN), a wide area network (WAN), or the like. As such, a website may comprise a collection of webpages conforming to a standard, such as hypertext markup language (HTML), or the like and may be renderable by a browser, such as Microsoft® Internet Explorer®, Mozilla Firefox®, Opera®, or the like. In addition, as used herein, a website may refer to a content provider service, such as a photo service (e.g., istockphoto®, Getty Images®, etc.), a news service (e.g., Reuters, Associated Press, etc.), or the like.

The systems and methods provided herein may provide for receiving, aggregating, and presenting aggregated user-submitted content. As used herein user-submitted content (e.g., a “content item” or more generally an “item”) may refer to any user authored and/or generated content, including, but not limited to: an image, an illustration, a drawing, pointer (e.g., a link, uniform resource indicator (URI), or the like), video content, Adobe Flash® content, audio content (e.g., a podcast, music, or the like), text content, a game, downloadable content, metadata content, a blog post or entry, a collection and/or arrangement of content items, or any other user-authored content. In addition, a content item may include, but is not limited to: a text posting in a threaded or un-threaded discussion or forum, a content item (as defined above) posting in a threaded or un-threaded discussion, a user-submitted message (e.g., forum mail, email, etc.), or the like.

As will be discussed below, the systems and methods described herein may aggregate user-submitted content using metadata associated with the content. As used herein, metadata (also referred to as “metadata tags” or “tags”) may refer to any data that describes and/or provides context to other data (e.g., content or other metadata). Metadata may include content, and, as such, may include any of the item types described above (e.g., text, video, audio, etc.). Metadata may be used to provide information data (e.g., another item), such as a title, a description, identify the type of the item (e.g., image, audio, video, composite, etc.), specify the subject matter of the item, provide location information (e.g., where the item was created and/or a location to which the item pertains), identify a timeframe for the item, or the like. As such, metadata may include, but is not limited to: descriptive text (e.g., a title, a description, authoring technique, etc.), keywords, time identifiers (e.g., a timeframe, a particular time, a duration, etc.), location identifiers (e.g., location coordinates, identify region, specify a particular neighborhood, provide an address, etc.), or the like. The systems and methods described herein may allow users to contribute metadata associated with one or more content items on the website.

Community content oriented websites may encourage quality content submissions by allowing other community users to rate user-contributed content and metadata presented thereon. The user ratings may be used to improve the quality of the website. For example, highly-rated content may receive more attention on the website than lower-rated content. As such, the highly-rated content may “represent” the website in the sense that users may judge the quality of the content available through the website based on the highly-rated content featured thereon. For example, the website may prominently feature highly-rated content on a “home” or “portal” page of the website, on a site banner, or the like. New users accessing the website may be presented with the featured, highly-rated content and become interested in exploring the other content available on the site. Similarly, inbound links to the website may feature the highly-rated content, which in turn, may increase traffic to the site. As such, the highly-rated content may act as an effective form of advertisement for the website to grow the site's user-base and community.

However, even if a website contains high-quality content, it may be difficult and/or impossible to feature and/or promote the content in the absence of high-quality metadata associated with the content. For example, a user may contribute a high-quality photograph of the Taj Mahal to a website. However, in the absence of effective, relevant metadata associated with the photograph, other users may not be able to find the photo. Moreover, in the absence of effective metadata, website-indexing services, such as search engines, web crawlers, and the like, may not be capable of detecting and/or categorizing the photograph for inclusion in search results. As such, the photograph may not attract new users and/or inbound links to the website.

In contrast, a photograph of the Taj Mahal that is associated with descriptive and relevant metadata may be used to attract new users to the website and/or generate inbound links. For example, a search engine Web crawler and/or indexing engine may access the metadata associated with the photograph and index the photograph and/or webpage associated with the photograph. When Internet users use the search engine to search for photographs and/or information related to the subject matter of the photo (e.g., search for “Taj Mahal”), an inbound link to the photograph and associated metadata on the website may be returned to the user. This may drive traffic to the website and attract new users.

Similarly, the system and methods described herein may provide for contextual metadata. For example, a user may contribute content related to a youth soccer match (e.g., photographs, video, etc.). Without metadata to provide context to the content, however, the content may not be of interest to very many users, nor is it likely to be particularly relevant to a user looking for “soccer photographs” in general. However, the content may be of significant interest to other users based on its context. For example, users who also attended the match, were in the area at the time the content was created, and/or know a participant on one of the teams may be interested in the content. Contextual metadata associated with the content, which identifies its location, time, and/or subject matter, may be used by these interested users (or an automated system, such as a Web crawler) to find the content.

The quality and quantity of metadata associated with content on a website may directly affect the nature of inbound links. For example, inaccurate and/or irrelevant metadata may result in false hits, where users may not get the content they expect. This may result in frustrated users, a possible reduction of inbound links to the website, and/or may even cause the search engine and/or indexing service to deemphasize and/or discount links to the website (e.g., place links to the website lower in a results list, remove links to the website, or the like). By contrast, high-quality and high-quantity metadata may be effective at attracting users and increasing inbound links. As such, websites site may encourage user-contributors to submit high-quality, relevant metadata.

In some embodiments, a website may be designed to encourage users to submit metadata with content items. For example, the website may provide entries where a user-submitter may submit various types of metadata. For instance, when uploading a content item, the website may provide input fields to allow users to submit metadata associated with the content item including, but not limited to: a content item title; a content item caption to provide a description of the content item; a content item technique and/or authoring description to describe how the content item was created and/or authored; additional tags to categorize and/or describe the content item and/or metadata item; a location tag or route tag may be used to indicate where a particular item was authored and/or identify a location to which the item pertains, a time tag may be used to indicate the time the item was created and/or a time to which the item pertains, and so on. Similarly, the website may allow other users to submit metadata (e.g., users who did not submit the content item may be allowed to submit metadata describing the content item).

The website may identify high quality metadata by allowing members of its user community to not only rate content items submitted to the site, but to also rate metadata associated with the content. As will be described below, the website may reward users for submitting high-quality, relevant metadata by including highly-rated metadata and associated content items in featured, topical sections of the website (e.g., an arena). Similarly, effective tagging of content and/or metadata may be rewarded by including appropriately tagged content and/or metadata in the arenas. Accordingly, the website may display metadata along with the items the metadata is intended to describe.

As used herein, an arena may refer to an aggregation of one or more content items, metadata items, or the like (e.g., items that that are related to a particular topic or that have other features in common (e.g., time, place, etc.)). For example, the photograph of the Taj Mahal discussed above, may be included in an arena directed to the Taj Mahal, an arena directed to India, and/or an arena directed to South East Asia, and so on. Similarly, an arena may include content related to a particular time, place, event, subject matter, or the like. For example, content related to a youth soccer match may be included in an arena directed to events occurring at a particular location (e.g., based on location-identifying metadata), occurring at a particular time (e.g., based on time-identifying metadata), and/or involving a particular set of participants (e.g., based metadata identifying the teams involved in the match).

Ratings of the metadata associated with a content item may be used to determine whether the particular content item should be included in a particular arena. For instance, in the Taj Mahal example, a user may submit a high-quality (and highly-rated) photograph of a salmon and, for whatever reason, apply a Taj Mahal tag to thereto. Other users of the website may rate the photograph's Taj Mahal tag as “not relevant.” When aggregating content relevant to the Taj Mahal, the salmon photograph may be excluded based on the low relevancy rating of the “Taj Mahal” tag. By contrast, a Taj Mahal tag associated with a photograph of the Taj Mahal may be rated by users of the site as “highly relevant.” The Taj Mahal photograph may be included in a Taj Mahal arena based on the rating of its “Taj Mahal” tag.

In addition, ratings associated with the content item and/or the metadata associated therewith may be used in selecting items for inclusion in an arena. For instance, a website may have many photographs of the Taj Mahal, each of which is associated with a highly rated Taj Mahal tag. The arena may be configured to include only a limited number of items in the arena. In this case, the content with the highest ratings may be selected for inclusion (e.g., if the arena specifies a maximum of five photographs, the five top rated photographs (that also have conforming metadata) may be included in the arena)). Similarly, the website may include metadata items in an arena. For instance, in an arena generated to describe a particular photographic technique, only the highest rated “authoring” metadata may be included in the arena.

In some embodiments, a website may construct one or more arenas a priori. For example, as discussed above, the website may construct arenas directed to geographical areas, points of interest, events, areas of topical interest (such as news events, political events, or the like), hobbies, authoring techniques, and the like. Alternatively, or in addition, arenas may be generated on-the-fly responsive to a website search and/or inbound link to the website. For example, an arena may be constructed for a particular user according to a location and/or timeframe of interest to the user. The user may have visited a particular location on a particular day and, as such, may be interested in an arena comprising content tagged with tags and/or contextual metadata identifying the location and/or timeframe of interest to the user.

Similarly, two or more users may construct an arena comprising “intersecting” content items. As used herein, intersecting content and/or metadata items may be those items that have one more features in common (e.g., as determined by the tags and/or metadata associated therewith). For example, intersecting items may have been obtained at and/or may relate to the same location, may have been obtained and/or may relate to the same time period, may pertain to the same subject matter, may have been generated using a similar authoring technique, or the like. For instance, two users may have a common interest (e.g. may follow the same sports league), and may have submitted content and/or may be linked to content related to the interest (e.g., content pertaining to attendance at league games). Therefore, the content items submitted by the users may be tagged similarly and/or may include similar metadata (e.g., may be identified as pertaining to similar locations, times, places, events, subject matter, or the like). Intersecting content may be aggregated by comparing the tags and/or metadata associated with a first user, to tags and/o metadata associated with a second user. The similarly tagged content items and/or metadata may be included in an arena, which, as described above, may include the “intersection” of the locations, events, and or subject matter interests of the users.

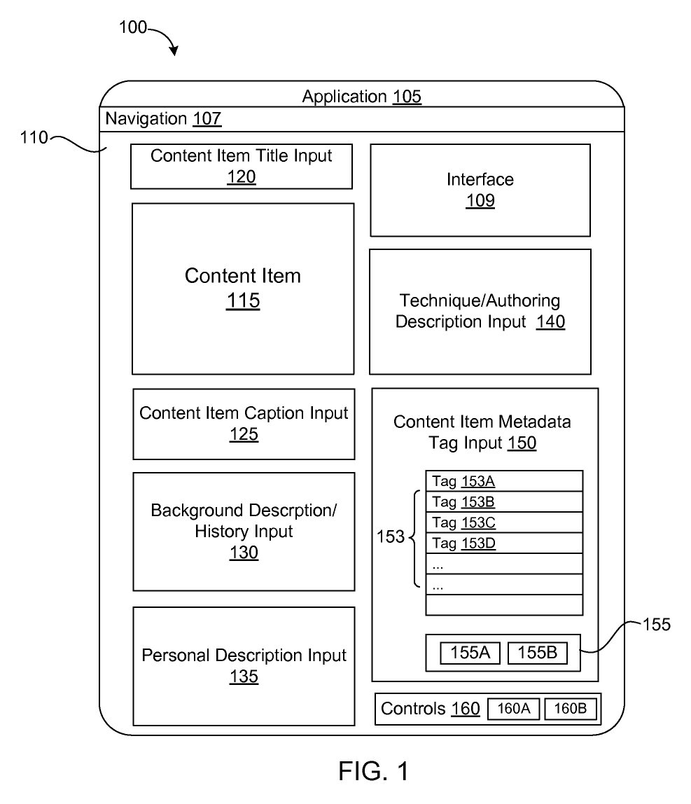

FIG. 1 depicts one embodiment of a content submission interface 100. The interface 100 may be displayed within an application 105, which may comprise a navigation component 107 and a display area 110. The application 105 may comprise web browser software, such as Microsoft Internet Explorer®, Mozilla Firefox®, or Opera®. The application 105 may be configured to display content formatted according to an HTML, Extensible Markup Language (XML), and/or another standard. Alternatively, or in addition, the application 105 may be a media player application and/or a custom software application configured to display the interface 100. Accordingly, the interface 100 may be configured for display on a computing device (e.g., personal computer), a mobile computing device (e.g., a cell phone, PDA, or the like), a multimedia device, a television, or the like.

The navigation component 107 may be used to enter a URI or other navigation data to access content available on a network (e.g., the Internet). A web server may transmit the content submission interface 100 to the application 105 (e.g., as HTML markup), and the application 105 may be capable of rendering the interface 100 as depicted in FIG. 1.

The content submission interface 100 may be presented within a display area 110, which may comprise a navigation interface 109, a content item 115, a content item title input 120, a content item caption input 125, a technique/authoring description input 130, content item metadata input 140, tag input 150, and submission controls 160.

As discussed above, the content item 115 may comprise an image, an illustration, a drawing, a pointer (e.g., a link, URI, or the like), video content, Adobe Flash® content, audio content (e.g., a podcast, music, or the like), text content, a game, downloadable content, metadata content, a blog post or entry, map, story, a collection and/or arrangement of content items, or any other authored content. As such, the content item 115 may be displayed in the interface 100 in various ways. For example, an audio content item 115 may be presented in an audio player component presented on the display area 110. A video content item 115 may be presented in a video player component (e.g., embedded Flash or the like) on display the area 110. A text content item 115 may be presented in a text display window comprising scrolling and/or paging functionality as necessary. An image content item 115 (e.g., a photograph) may be presented in a graphic display on the display area 110, and so on.

In addition, in some embodiments, even after the user has uploaded the content item 115 and/or submitted one or more metadata items, the user may access the interface 100 to update and/or edit the content item 115, the metadata, and/or the tags using the interface 100.

The content item title input 120 may allow the user to provide a descriptive title for the content item 115. As discussed above, a content item title may be used to describe and/or categorize the content item 115. The content item caption input 125 may be provided to allow the user to input a description of the content item 115. For example, a user may describe a content item 115 comprising a photograph of a salmon as a “photograph of a Sockeye salmon in the Klamath River.”

The background description/history input 130 may be used to provide a detailed and in-depth description of a background and/or history of the subject matter of the content item 115. For example, for a photo of the Taj Mahal, a user may provide metadata describing the history of the Taj Mahal, details of its construction, its location, its cultural/religious significance, and so on, in the background description/history input 130. Similarly, for an audio recording of a particular instrument, the user may enter a description of the instrument, the evolution of the instrument over time, a listing of famous pieces of music written for the instrument, and the like into background description/history input 130.

The personal description input 135 may be used to provide personal information related to the content item 115. Referring to the Taj Mahal photograph example, a user may provide a personal account of his/her a trip to the Taj Mahal in the personal description input 135. Similarly, for a video content item 115 depicting a news event (e.g., auto accident, robbery, political speech, Space Shuttle launch, etc.), a user may enter his/her personal experiences related to the event into personal description input 135.

The technique/authoring description input 140 may be used to provide a description of the authoring process and/or techniques used to create the content item 115. For instance, in the Taj Mahal photograph example, a user may describe the type of camera used to capture the photograph, the camera settings, the camera lens, a description of any post processing performed on the photograph, and the like. Other content item types, such as video content, audio content, and the like, may be described in the context of tools and techniques used to generate the content item 115. For example, the type of video camera, video codec, and the like may be input into 140 to describe the creation of a video content item 115. The type of instruments used, the recording equipment, audio capture bit rate, audio mixer settings, and the like may be provided to describe the creation of an audio content item 115.

The user may provide one or more keywords or tags via input 150 to categorize and/or describe the content item 115. The tag input 150 may include a control 155, comprising an add tag input 155A and a remove tag input 155B. Selection of the add tag input 155A may add a new tag 153 to a tag list. Selection of the remove tag input 155B may remove a tag 153 in the tag list. The interface 150 may be adapted to receive various types of tags including, but not limited to: text tags (e.g., keywords), location tags (e.g., coordinates), time tags (e.g., a time value, time zone, etc.), regional information, or the like. Accordingly, the interface 150 may include a map component (not shown), through which a user may provide a location coordinate tag, a time input component (not shown) to receive a time tag, a selection box (not shown) to provide one of a plurality pre-set tagging values, or the like.

In addition, although not shown in FIG. 1, the metadata inputs 120, 125, 130, 135, and 140 may comprise a tag input similar to the tag input 150. The tag input may be used to categorize and/or describe the metadata. For example, a tag may be applied to the background/history metadata input 130 to identify the metadata 130 as a particular type of metadata. For example, if the metadata entered at 130 were a description of the history of the content item 115, a “historical” tag may be applied to the input. Similarly, metadata entered into technique/authoring description input relating to post processing steps used in the creation of the content item 115 may be tagged as “post processing,” and so on.

Alternatively, or in addition, metadata and/or tagging information may be obtained from the content item 115 itself. For instance, the device used to capture and/or author the content item 115 may be configured to embed metadata within the item 115 (e.g., as a digital watermark or other data embedded within the content). For example, an image may include metadata identifying the camera, lens, and/or settings used to generate the image. Editing software may embed an identifier of the program and/or may provide indicators of the editing operations performed on the image (e.g., as undo information or the like). A photograph or video captured using a GPS enabled device (e.g., cell phone) may include location indicators (location coordinates). Similarly, the capture device may embed time information, such as the time the content item 115 was captured, modified, and/or uploaded through the interface. Accordingly, the metadata associated with a content item need not be limited to the metadata inputs displayed in FIG. 1, but may be extracted from information embedded within the content item 115 and/or received via one or more of the metadata inputs 125, 130, 135, 140, and/or 150.

The interface 100 comprises controls 160, which may include an upload/save input 160A and a cancel input 160B. Selection of the upload input 160A may cause the content item 115 to be uploaded and stored on the website. Selection of the save input 160B may cause content item 115, the contents of the content item input 120, the contents of the content item caption input 125, the contents of the background description/history input 130, the contents of the personal description input 135, the contents of the technique/authoring description input 140, and the contents of the content tag input 150 to uploaded to, and stored on a data storage system of the website. Uploading and/or storing may comprise recording the content item 115 and any associated metadata on a computer-readable storage medium. The uploading and/or storing may further include extracting metadata, which, as described above, may be embedded within the content item 115. Selection of the cancel input 160C may cause the contents of the interface 100 to be cleared.

Although interface 100 depicts content item 115 with metadata inputs, including: the content item title input 120, the content item caption input 125, the background description/history input 130, the personal description input 135, the technique/authoring description input 140, and the tag input 145, one skilled in the art would recognize that any number of metadata inputs could be included in interface 100. As described above, a map component (not shown) could be used to assign location and/or route metadata and/or tagging information to the content item. A time input (not shown) could be used to assign a time and/or timeframe related tags to the content item, and so on. In addition, or alternatively, interface 100 could comprise a multi-step interface (e.g., a wizard), wherein the content item 115 and/or one or more metadata inputs (e.g., inputs 120, 125, 130, 135, 140, and/or 150) are each displayed in one or more respective interfaces.

As discussed above, once a user has uploaded a content item (e.g., the content item 115 of FIG. 1), other users may be able to access the content item on the website. In addition, users may be able to rate the content item, rate the metadata associated with the content item, and/or rate tags associated with the content item and/or the metadata. In some embodiments, other users may be allowed to submit additional metadata and/or tags describing the content item 115.

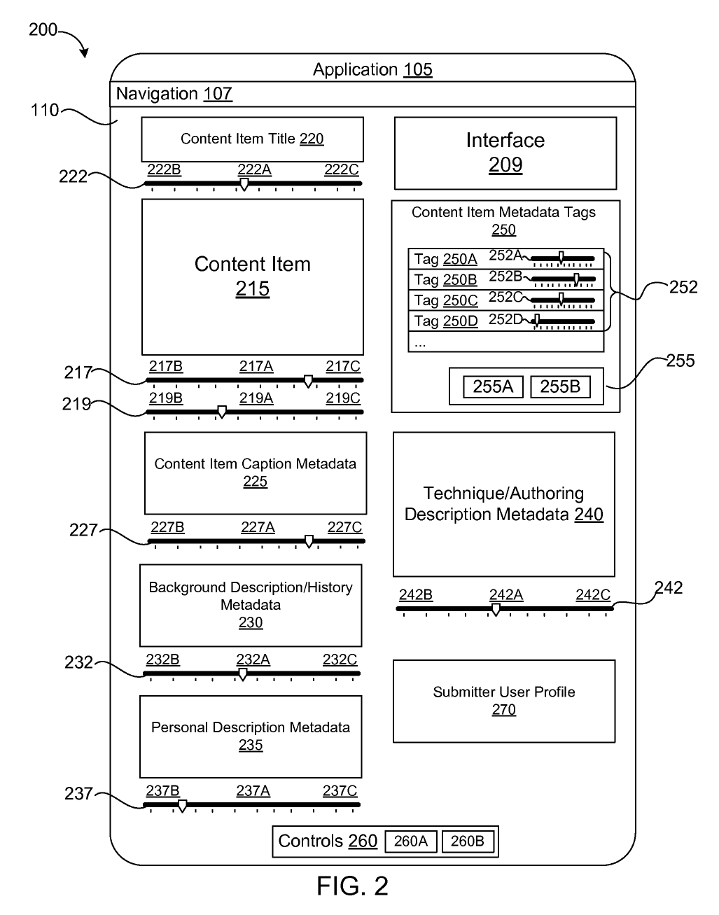

FIG. 2 depicts one embodiment of content presentation interface 200. The interface 200 may comprise one or more rating inputs to allow the user to rate the presented content item 215 and associated metadata 220, 225, 230, 235, 240, and 250. As shown in FIG. 2, the content item 215 may be presented along with the metadata that describes the content item 215. Presenting the item 215 with its associated metadata 220, 225, 230, 235, 240, and 250 may allow users of the interface 200 to provide effective feedback (e.g., ratings) of the metadata.

The interface 200 may be presented in an application 105, which, as discussed above, may include a navigation component 107 and a display area 110. As such, the interface 200 may be provided as a component of a website (e.g., as one or more webpages and/or as web accessible content hosted on a website).

In some embodiments, the he display area 110 may be configured to render HTML data. Accordingly, the interface 200 may be implemented as a webpage, which may comprise a content item 215, a content item title 220, content item caption metadata 225, background description/history metadata 230, personal description metadata 235, technique/authoring description metadata 240, content item tags 250, controls 260, and a submitter user profile 270.

The interface 200 may include one or more rating inputs 217, 219, each of which may comprise a respective rating input title 217A, 219A, to indicate an aspect or category of the content item 215 to be rated. For example, if the content item 215 were a photograph, the rating input 217 may be a rating of the photograph's subject appeal. As such, the rating input title 217A may be “subject appeal.” Similarly, the rating input 219 may be a rating of the photograph's composition. In this case, the rating input title 219A may be “composition.” Each of the rating inputs 217 and 219 may also comprise range indicators 217B, 217C and 219B, 219C. These range indicators may provide a scale for the rating inputs. For example, the range indicator 217B may be “unappealing” to indicate a low rating for subject appeal, and the range indicator 217C may be “appealing” to indicate a high rating for subject appeal. The rating input 219 may comprise similar range indicators 219B and 219C. As shown in FIG. 2, the rating inputs 217 and 219 may comprise respective slider controls. However, the interface 200 is not limited in this regard, and other input types could be used including, but not limited to: selection boxes, text input fields, numerical input fields, or the like.

FIG. 2 depicts two rating inputs 217 and 219 associated with the content item 215; however, any number of rating inputs, corresponding to any number of different aspects of the content item 215, could be included under the teachings of this disclosure. Moreover, the nature of the rating inputs 217 and/or 219 may be adapted according to the type of content item 215 presented in the interface 200. For instance, for an audio content item 215, rating inputs could be provided directed to “tonal qualities,” “beat,” “melody,” and the like of the audio content item 215. As such, this disclosure should not be read as limited to any particular number of rating inputs to rate any particular aspect or category of the content item 215.

The content item 215 may be associated with metadata and/or tags, which may be used to describe various aspects of the content item 215, provide context and background to the content item 215, describe the creation process and/or authoring of the content item 215, categorize the content item 215, provide context for the content item 215 (e.g., location, time, subject matter), and the like. The interface 200 may display the metadata and/or tags associated with the content item 215, and may allow users to submit ratings of the metadata and/or tags.

A content item title 220 may be used to describe and/or categorize the content item 215. The content item title 220 may be displayed in display area 110 in association with the content item 215. A content item title rating input 222 may be provided to allow a user to rate the content item title 220. For example, where the content item title 220 is intended to categorize and/or describe the content item 215, the content item title rating 222 may allow the user to rate whether the user feels that the content item title 220 is “helpful” or “non-helpful,” “relevant” or “non-relevant,” or the like. The rating input title 220 and indicators 222A and 222C may be labeled accordingly. As discussed above, the content item title 220 may be associated with any number of rating inputs 222 relating to any aspect of the content item title 220 (e.g., relevance, descriptiveness, originality, etc.).

The content item caption metadata 225 may be provided to allow an author of the content item 215 (or some other user) to describe the content item 215. The content item caption metadata 225 may describe the subject matter of the content item 215. The content item caption 225 may be associated with a content item caption metadata rating input 227 to allow a user to submit a rating of the content item caption 225. The content item caption rating input 227 may comprise a title 227A, low range indicator 227B, and a high range indicator 227C, which may comprise descriptive text to assist the user in entering a rating of the content item caption 225.

The background description/history metadata data 230 may allow the submitter of the content item 215 (or some other user) to describe a background of the content item 215 and/or relate the history of the content item 215.

A background description/history metadata rating input 232 may be provided to allow users to rate metadata 230. Rating input 232 may comprise a title 232A, a low-range indicator 232B, and a high-range indicator 232C. The rating title 232A may identify the aspect of the background description/history metadata 230 being rated (e.g., rated based upon accuracy, relevance, completeness, descriptiveness, and the like). The low-range indicator 232B and high-range indicator 232C may provide indicators relevant to the aspect of the metadata 230 being rated (e.g., for a rating related to “accuracy,” indicator 232B may be “inaccurate” and indicator 232C may be “inaccurate”). Although FIG. 2 shows only a single rating input 232 associated with the background description/history metadata 230, any number of rating inputs could be included on interface 200 directed to rate any aspect of the metadata 230.

The personal description metadata 235 may allow the submitter of the content item 215 (or some other user) to provide a personal account and/or description of the content item 215 and/or relate a personal account related to the content item 215, or the like.

A personal description metadata rating input 237 may be provided to allow users to rate the metadata 235. The rating input 237 may comprise a title 237A, a low-range indicator 237B, and a high-range indicator 237C. The rating title 237A may identify an aspect and/or category to which the rating 237 pertains (e.g., rated based upon writing style, quality, and the like). The low-range indicator 237B and the high-range indicator 237C may provide indicators relevant to the aspect of the metadata 230 being rated (e.g., for a rating 237 related to “quality,” indicator 237B may be “poor” and indicator 237C may be “high”). Although FIG. 2 shows only one rating input 237 associated with the personal description metadata 235, any number of rating inputs could be included on interface 200, directed to any rating aspect and/or rating category of metadata 235.

The technique/authoring metadata 240 may comprise metadata describing how the content item 215 was created and/or authored. For example, the metadata 240 of an image content item 215 may comprise a description of the camera used to capture the image 215, the camera settings, the image file format, image compression settings, post processing steps, and the like.

A technique/authoring metadata rating input 242 may be provided on the interface 200 to allow a user to rate the metadata 240. The rating input 242 may comprise a title indicating the aspect of the technique/authoring description metadata 240 to be rated (e.g., completeness, helpfulness, detail, etc.). The rating input 242 may comprise a low-range indicator 242B and high-range indicator 242C. As discussed above, any number of rating inputs could be included on interface 200, directed to any rating aspect and/or rating category of metadata 240.

Although a particular set of metadata and metadata rating inputs are described herein, additional metadata types and/or rating inputs could be included under the scope of this disclosure. For example, location or route metadata in the form of a map could be included. A rating for location-identifying metadata may be a simple “accurate” or “inaccurate” selection and/or may be comprise a range of ratings (e.g., provide a proximity rating, such as “close,” “general proximity,” to “distant” or “unrelated”). Other metadata types may include corresponding displays and/or rating interfaces (e.g., time-identifying metadata, subject matter identifier metadata, and so on).

Interface 200 may comprise content item tags 250. The tags 250 may be applied by the submitter of the content item 215 (or another user) to describe and/or categorize the content item 215. Each of the tags 250A-250D may have a corresponding tag rating input 252A-252D. The tag rating inputs 252A-252D may allow a user to rate the tags based on, for example, the relevance of the tag to the content item 215 and/or other metadata 220, 225, 230, 235, and 240, and the like. Although not depicted in FIG. 2, each metadata keyword rating input 252A-252D may comprise a title (not shown), a low range indicator (not shown), and a high range indicator (not shown) substantially as described above. For example, the title of one or more of the metadata keyword rating inputs 252A-252D may be “relevance,” the low rating indicator may be “not relevant,” and the high rating indicator may be “highly relevant.” The interface 200 may display tags of various types, including, but not limited to: text tags (e.g., key words), location tags (e.g., coordinates, routing information, etc.), time tags, and the like. The display 250 and/or rating inputs 252 of the tags may be adapted to the type of tag displayed therein. For example, a location tag may be displayed within a map component (not shown); a time tag may be displayed within a time display component, and so on. Although not shown in FIG. 2, tags may be applied to metadata items 220, 225, 230, 235, and/or 240 as well. The tags applied to the metadata may be rated as described above.

As will be discussed in additional detail below, the metadata, metadata ratings, the tags 250, and/or the tag ratings 252 may be used in determining whether a particular content item 215 and/or metadata item 220, 225, 230, 235, and 240 should be included in an arena. For example, to generate an arena related to the Taj Mahal, one or more text tags may be compared against metadata (tags) associated with the content (e.g., a “Taj Mahal” tag, an “Africa” tag, a “Mountain” tag, and the like). Similarly, a location identifying target tag may be used to identify content items 215 acquired and/or related to a particular location. The text tags, or other aggregation criteria (e.g., key words, location ranges, time ranges, etc.), may be used to search for one or more content items and/or metadata items on the website that are relevant to a topic, interest, event, or the like. For example, the content item 215 may be a photograph of the Taj Mahal. As such, a “Taj Mahal” tag 250 may be used to describe and categorize the content item 215. Since the content item 215 is directly relevant to the Taj Mahal, other users may rate the “Taj Mahal” tag 250 as highly relevant to the content item. When constructing an arena on a particular topic (e.g., the Taj Mahal), the website may search the tags 250 assigned to content items and associated metadata on the website. Content items and/or metadata having a related tag (e.g., a “Taj Mahal” tag) may be considered for inclusion in the arena. The rating of the relevant tag may be used to determine whether the content item and/or associated metadata should be included in the arena; content items and/or metadata having a highly-rated “Taj Mahal” tag may be include in the arena, while content items and/or metadata having a low-rated “Taj Mahal” tag may be excluded from the arena.

The metadata and/or tags associated with the content item 215 may be used to select the content item for inclusion in other types of arenas (e.g., an arena comprising content authored at and/or related to a particular location and/or time). For example, an arena may be created from content items related to a particular location and/or acquired at particular time (e.g., in a particular park on a Sunday afternoon). The location and/or time metadata (or tags) associated with the content items (e.g., content item 215) may be used to select content items for inclusion in the arena (e.g., to select items related to the location and/or timeframe of interest in the arena). Different criteria for selection may be used to construct different types of arenas. For example, and as discussed above, the criteria for inclusion in a particular arena may be based upon tags and/or metadata of the content items submitted by one or more other users. The entries in such an arena may comprise an “overlap” or “intersection” between the users' content items (e.g., the content items of the users that are related with respect to location, time, and/or subject matter may be included in the “intersection” arena).

The interface 200 may include a submitter user profile 270. The submitter user profile 270 may display user profile information about the submitter of the content item 215 and may include, but is not limited to: a user name, user contact information (e.g., email address, instant messenger address, etc.), a user avatar, and the like. In addition, the user profile 270 may include one or more user ratings, indicating various user-community ratings of content and/or metadata submitted by the user to the website. As will be discussed below, selection of content for inclusion into an arena may be based on a user rating of the submitter of the content (e.g., submissions from highly rated users may be included even if the content and/or metadata have not yet been rated by other users).

The interface 200 may include controls 260, which may comprise a submit input 260A and a cancel input 260B. The submit input 260A may cause the ratings provided in rating inputs 217, 219, 222, 227, 232, 237, 242, and 252 to be submitted to the website. Submitting the ratings may include storing the ratings on a computer-readable storage medium. The cancel input 260B may cause the ratings provided in the rating inputs 217, 219, 222, 227, 232, 237, 242, and 252 to be discarded.

The website may receive ratings submitted via the interface 200, or other interfaces provided by the website, and store the ratings in a ratings database. The ratings received from users of the website may be aggregated to calculate an overall rating of the content item 215, the metadata 220, 225, 230, 235, 240, and/or the tags 250. In some embodiments, the ratings may be aggregated by averaging the ratings received from different users of the website. In other embodiments, the aggregation may comprise weighing the ratings based on a rating weight of the website users (e.g., the ratings of some users may be given a greater weight than the ratings of other users, etc.).

In some embodiments, the rating used to select an item for inclusion in an arena may be a composite rating (e.g., a combination of a content item and metadata rating). A composite rating may be used where the content item and metadata item are to be used together in the arena. For example, in an arena directed to an authoring technique, a content item may be displayed along with its associated technique/authoring description metadata. Accordingly, the rating of both the content item and the metadata may be evaluated for the purposes of arena selection. In other arenas, content items and/or metadata items may be separately selected for inclusion in the arena. Alternatively, or in addition, one or more rating aspects of categories of a content item or metadata item may be combined in a rating comparison. For example, in some cases certain aspects of the content item and/or metadata may be more important to the arena than others. For example, in an arena directed to a particular authoring technique, a rating of the technique may be emphasized over other aspects of the content (e.g., a photograph composition rating may be emphasized over its “subject appeal” rating).

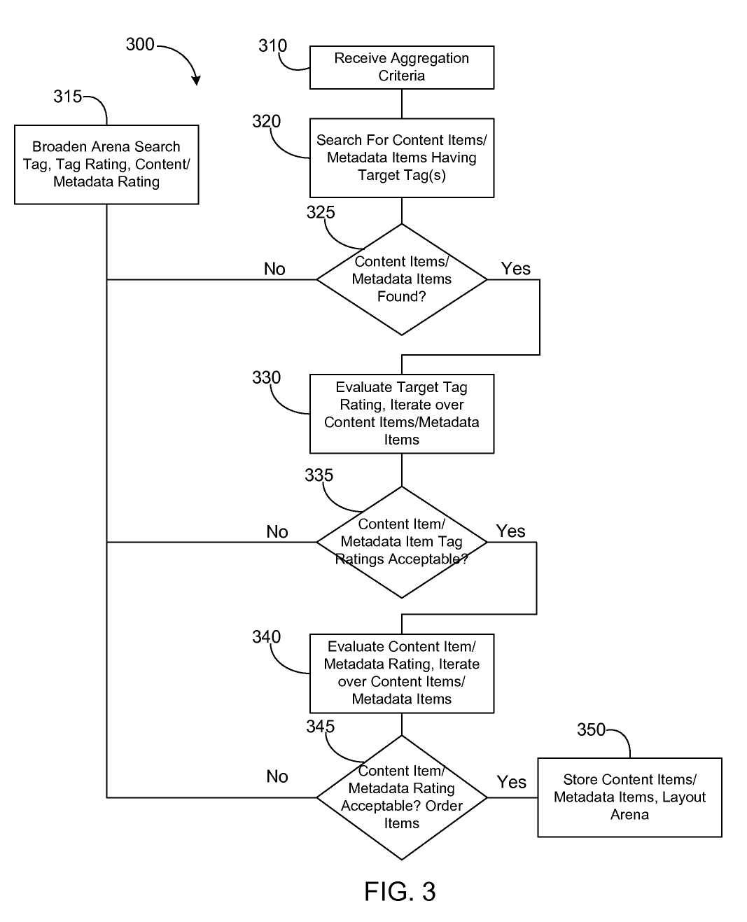

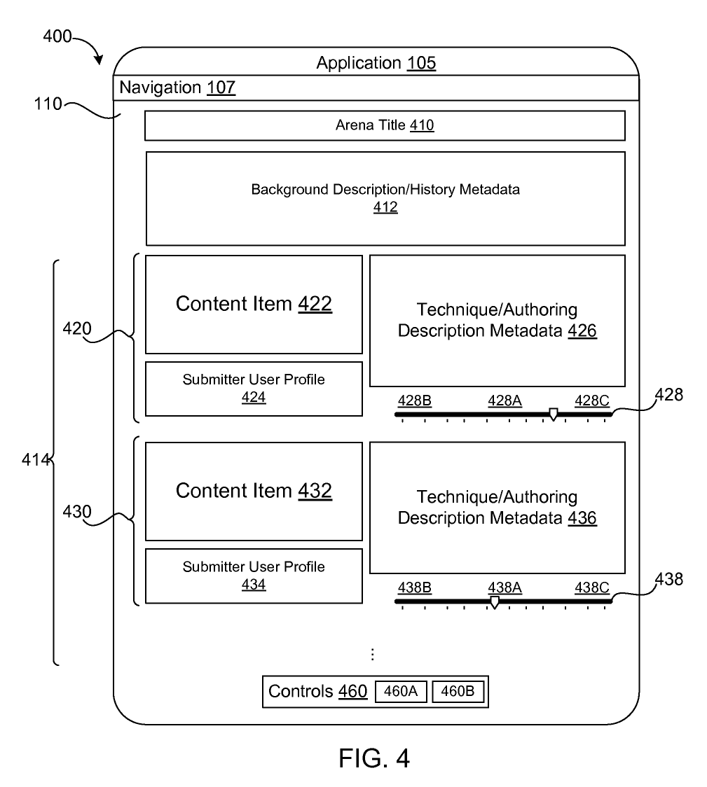

FIG. 3 is a flow diagram of one embodiment of a method for aggregating user-submitted content. The method 300 may comprise one or more machine executable instructions stored on a computer-readable storage medium. The instructions may be configured to cause a machine, such as a computing device comprising a processor, to perform the method 300. In some embodiments, the instructions may be operable on the processor of the computing device. The instructions may be embodied as one or more distinct software modules on the storage medium. One or more of the instructions and/or steps of method 300 may interact with one or more hardware components, such as computer-readable storage media, communications interfaces, or the like. Accordingly, one or more of the steps of method 300 may be tied to particular machine components.

At step 310, aggregation criteria may be received. The aggregation criteria may comprise one or more text tags to specify a topic for the arena, one or more location identifiers, one or more time identifiers, or any other criteria known in the art (e.g., logical operators, Boolean operators, wildcards, keywords, identifiers, ontological concepts, etc.). As discussed above, an arena may include content items as well as metadata. Accordingly, the term “item” may be used to refer to content items and/or metadata to be included in an arena.

Aggregation criteria defining an arena topic may be determined a priori by an administrator or user of the website (e.g., the website administrator, or other website user, may select one or more keywords to use as a topic). As discussed above, an arena may be directed to any number of topics, such as landmarks (e.g., Taj Mahal, Mount Kilimanjaro, etc.), regions (e.g., Asia, the South West United States, etc.), authoring techniques (e.g., black-and-white photography, stop motion animation, etc.), news events (e.g., political rallies, sports events, etc.), weather-related events (e.g., avalanche, storms, etc.), points-of-view (e.g., environmentalism, industrialism, etc.), philosophies and/or religion (e.g., Catholicism, nihilism, etc.), location, timeframe, subject matter, and the like. The aggregation criteria received at step 310 may, therefore, specify any number of keywords, terms, topics, timeframes, locations, events, users, or the like.

Alternatively, or in addition, the arena topic may be selected on-the-fly. For instance, an arena topic may be selected based upon a user search entered into a search engine hosted by the website and/or a third-party search provider (e.g., Google®, Microsoft Live®, or the like). For example, a user may provide a search term to a website, such as “Mount Kilimanjaro.” The search engine may provide a link to the website directed to a “pre-generated” arena relating to “Kilimanjaro.” Alternatively, the search engine may provide a link to the website that will generate an arena related to “Kilimanjaro” on-the-fly (e.g., as it is requested by the search engine). As such, the methods and systems disclosed herein to generate arenas may be used to generate one or more arenas before they are requested by users, or may be used to generate arenas on-the-fly as requested. Therefore, the aggregation criteria may be received in real time responsive to a search, a query, or the like.

Similarly, aggregation criteria may be generated in response to more contextual queries, such as “Smith Park, Sunday afternoon.” Responsive to this query, aggregation criteria comprising tags to select content items related to Smith Park and/or acquired on Sunday afternoon may be generated. Alternatively, or in addition, the aggregation criteria of step 310 may be generated by specifying one or more other users and/or user groups. In this case, the aggregation criteria may include tags to select content items that are common to the identified users; the aggregation criteria may be automatically generated using metadata associated with items (content items and/or metadata) submitted by the one or more users. (e.g., content items that “intersect” in location, time, subject matter, or the like, between the users and/or groups).

The aggregation criteria may further comprise one or more rating thresholds. For example, a threshold may specify a relevancy rating threshold for metadata and/or tags. A relevancy rating threshold may require that an item's conforming metadata (e.g., the metadata associated with the item that conforms to the aggregation criteria) have a particular rating (e.g., be rated as “relevant.”) This may prevent selection of poorly categorized items. Similarly, an item rating threshold may be established to require that any selected items be rated above a certain threshold level (e.g., to ensure that highly-rated, quality items are selected). Alternatively, or in addition, a submitter rating threshold may be included in the aggregation criteria to select items that were submitted by highly-rated submitters (e.g., according to a user rating of the submitter). In some embodiments, one or more of the thresholds may override another one of the thresholds (e.g., an item submitted by a highly rated submitter may be selected even if the item itself does not have a sufficiently high rating and/or even if the metadata associated with the item does not satisfy the metadata rating threshold). The aggregation criteria is not limited to any particular set of tags and/or rating threshold, and could include any number of different types of tags, thresholds, and/or other selection criteria (e.g., the aggregation criteria may specify a minimum or maximum number of items to be included in the arena, may specify content item and/or metadata rating thresholds, may provide rating weighting factors, and so on).

At step 320, a website database may be searched to select one or more content items and/or metadata items for inclusion in the arena. The database may comprise a computer-readable storage medium comprising a plurality of items, each item having metadata associated therewith. The selection of step 320 may be based on the metadata associated with the items; items that have metadata that conforms to the aggregation criteria (e.g., has metadata that includes one or more tag(s) specified in the aggregation criteria) may be selected. For example, to generate an arena for Mount Kilimanjaro, the search at step 320 may comprise searching for content items and/or metadata items having a target tag of “Kilimanjaro,” “Africa,” “Mountain,” or the like. Alternatively, or in addition, location and/or time-related selection criteria (e.g., tags) may be queried. In the case of location and/or time criteria, a proximity metric may be employed, such that content items within a particular threshold distance and/or time of the target tag(s) may be selected at step 320.

At step 325, if less than a threshold number of results are found, the flow may return to 310 via 315, where the aggregation criteria may be modified to be broader (e.g., to select additional items at step 320). The modified aggregation criteria may be used as a basis for another search at step 320. For instance, if no content items having a “Kilimanjaro” tag are found at step 320, the search at step 320 may be expanded to search for “Mountain,” and “Africa” tags, or the like. Similarly, a proximity threshold (e.g., as applied to location and/or time metadata) may be increased. Otherwise, if at least a threshold number of content items and/or metadata items are found, the flow may continue to step 330.

At step 330, a rating of the conforming metadata associated with the items selected at step 320 may be evaluated. As discussed above, the rating of metadata may indicate whether the metadata is relevant and/or effective at describing the data associated therewith. The rating of metadata and/or metadata tags may be derived from user-submitted ratings (e.g., ratings submitted through the interface 200 of FIG. 2). Users may identify and rate irrelevant or nonsensical metadata and/or tag information appropriately (e.g., a “Kilimanjaro” tag or metadata item on a photograph of a salmon). Tags that are relevant and/or effective at describing data may receive high ratings. Similarly, location, time and/or subject matter metadata and/or tags may be rated as “accurate,” “inaccurate,” and so on. Step 330 may include an iteration, which may perform step 330 for each of the items selected at step 320.

At step 335, the metadata associated with an item selected at step 320 may be evaluated. The evaluation may comprise comparing the rating of the conforming metadata to a threshold, which may be defined in the aggregation criteria received at step 310. The evaluation may further include comparing the number of user-submitted ratings of the conforming metadata to a threshold (e.g., if the metadata has not been rated by a threshold number of users, the metadata may fail the evaluation of step 335).

In some embodiments, the evaluation of step 335 may include evaluating a user rating of the submitter of the metadata and/or of the item associated with the metadata. An item submitted by a highly-rated submitter may be included in the arena at step 335 even if the conforming metadata associated therewith does not satisfy the metadata rating threshold and/or has not been rated by a sufficient number of users. Alternatively, or in addition, the metadata rating threshold and/or the number of metadata ratings required at step 335 may be adaptive (e.g., may be proportional to the submitter's user rating). For example, the threshold(s) applied at step 335 may be lower for higher rated users, and higher for lower rated users.

If the evaluation of step 335 indicates that the conforming metadata of an item does not satisfy the metadata rating threshold, rating count threshold, and/or user rating threshold discussed above, the item may be removed from the aggregation. Items that satisfy the evaluation may be retained.

At step 335, if, after iterating over all of the items selected at step 320, less than a threshold number of items remain in the aggregation, the flow may return to step 310 via 315, where an alternate set of aggregation criteria may be established (e.g., the tags may be broadened, one or more thresholds may be lowered, or the like); otherwise, the flow may continue to 340.

In some embodiments, the items remaining the aggregation after step 335 may be included in an arena at step 350 (e.g., steps 340 and 345 may be omitted). In the FIG. 3 example, the flow may continue to step 340, where a rating of the items in the aggregation may be evaluated.

At step 340, the items remaining in the aggregation may be evaluated and/or compared to one another. In some embodiments, the aggregation criteria may define a minimum rating threshold for items included in the arena. These thresholds may prevent low-quality content from being included in the arena. Alternatively, or in addition, the aggregation criteria may only require a certain number of items in the arena and/or may only require a particular number of certain item types (e.g., specify five image items, one authoring description item, and two video items). For example, an arena directed to a particular authoring technique (e.g., black and white, hand developed photograph) may include three exemplary photographs and one technique/authoring description metadata item. Step 340 may include an iteration, which may perform step 345 for each of the items remaining in the aggregation after step 335.

At step 345, a rating of the content item and/or metadata item may be compared to a rating threshold, which may be defined in the aggregation criteria. As discussed above, the comparison at step 345 may comprise a composite comparison of a rating of the content item and the metadata item together, or the ratings of the content item and metadata item may be evaluated separately.

In some cases, the ratings of a content item may be evaluated separately from its associated metadata. For instance, an arena on Mount Kilimanjaro may require that content items in the arena (e.g., photographs of the mountain) have a composite rating (e.g., a combination of all rating categories of the content item) of at least eight out of ten. Any photographs having a composite rating lower than the threshold may be removed from consideration at step 345. Similarly, the aggregation criteria may further require that any metadata item to be included in the arena (e.g., background/history metadata 230 in FIG. 2, personal description metadata 235 in FIG. 2, or the like) must be rated at least seven out of ten. Any metadata having a composite rating lower than the threshold may be removed from the aggregation at step 345. Accordingly, at step 345 the evaluation of content item ratings may be separate from the evaluation of metadata ratings. Other arenas, however, may be more permissive. For example, an arena comprising content related to a youth soccer game may not require high ratings for inclusion and/or may not include the rating evaluation step 345 at all. The decision whether to include a particular content item (e.g., photograph) may be independent of the decision whether to include an associated metadata item (e.g., background/history metadata).

In some embodiments, the aggregation criteria may require certain items be added (or rejected) jointly. Accordingly, at step 345, the ratings of two or more items (e.g., a content item and associated metadata) may be evaluated together (e.g., a combined rating of the content item and metadata may be evaluated). For example, an arena directed to a particular authoring method or technique (e.g., black and white photography, stop motion animation, or the like) may specify aggregation criteria that requires that the technique/authoring description metadata be included with its corresponding content item. The content items and metadata data may be used together in the arena (e.g., the content item may be used along with technique/authoring description metadata in the arena). As such, at step 345, the ratings of both the content item and the applicable metadata item may be compared to a threshold. In this case, if either the content item rating or metadata rating is below a threshold, the content item and associated metadata item may be removed from consideration at step 345.

As discussed above, various aspects or categories of a content item may be rated (e.g., the subject appeal, technical merit, and the like). Similarly, various aspects of metadata may be rated (e.g., completeness, descriptiveness, and the like). The rating comparison of step 345 may include various rating categories, which may be selected according to the role the item is to play in the arena. For example, in an arena directed to a particular content item authoring technique (e.g., stop motion animation), the comparison at step 345 may place particular emphasis on a content-item's “technical merit” rating, and less emphasis on the content-item's other ratings (e.g., “subject appeal” and the like). Similarly, the comparison at step 345 may place extra emphasis on a “completeness” rating of the metadata associated with the content item. Therefore, the comparison at step 345 may comprise more than one rating comparison. For example, the rating comparisons may comprise a first set of content item rating comparisons and a second set of metadata rating comparisons. In some embodiments, the first set of comparisons may be combined with the second set of comparisons to determine whether the content item and associated metadata should be included in the arena. Alternatively, as discussed above, the content item ratings may be compared separately from the metadata ratings.

The ratings used and/or thresholds applied thereto, may be adapted according to the type of arena generated by the method 300. For example, an arena directed to a topic of general interest (e.g., black and white photography) may have aggregation criteria that requires high ratings standards for the content items included therein, whereas an arena that has a more limited appeal and/or caters to a more casual interest (e.g., a particular event, location, hobby, or the like), may have aggregation criteria that are more permissive. In addition, certain ratings may be emphasized according to the nature of the arena. An arena directed to a particular location and/or timeframe may emphasize the location and/or timeframe metadata and/or tags of content as opposed to other factors.

In some embodiments, the evaluation of step 345 may include comparing the number of user-submitted ratings of the item to a threshold (e.g., if the item has not been rated by a threshold number of users, the item may fail the evaluation of step 345).

In some embodiments, the evaluation of step 345 may include evaluating a user rating of the submitter of the item. An item submitted by a highly-rated submitter may be included in the arena at step 345 even the rating of the item does not satisfy the item rating threshold and/or has not been rated by a sufficient number of users. Alternatively, or in addition, the item rating threshold and/or the number of item ratings required at step 345 may be adaptive (e.g., may be proportional to the submitter's user rating). For example, the threshold(s) applied at step 345 may be lower for higher rated users, and higher for lower rated users.

The one or more rating comparisons performed at step 345 may be used to order the content items and/or metadata to be included in the arena. For instance, if the arena can only include a certain number of content items and/or a certain number of metadata items of a particular type, the rating comparisons of step 345 may be used to determine which content items and/or metadata items are to be included in the arena (e.g., the arena may take the top five rated content items, the top three rated background/history metadata items, and so on). The ordering and/or selection of the content items at step 345 may further include comparison of a user rating of the items' submitters (e.g., items submitted by more highly rated submitters may be given precedence over items from lower rated submitters).

In addition, at step 345, the method 300 may determine whether a sufficient number of acceptably rated items have been aggregated. As discussed above, the aggregation criteria received at step 320 may specify a minimum and/or maximum number of items to be included in the arena. If, according to the aggregation criteria, a sufficient number of acceptably rated items have been aggregated, the flow may continue to step 350; otherwise, the flow may return to step 310 via step 315 where the aggregation criteria may be broadened as described above.

At step 350, the aggregated items may stored in the website. The storing may include storing copies of the aggregated items in a computer-readable storage medium, storing links to the items, or the like. In addition, step 350 may include generating a user interface to present the aggregated content items, which may include formatting the items for presentation to users of the website. As discussed above, one or more arenas may be generated a priori by the website and stored for access by the users of the website, indexing by search engines, and the like. In addition, arenas may be constructed on-the-fly in response to a search on the website and/or an inbound link to the website. Arenas that are created on-the-fly may be stored on the website for later use. Alternatively, arenas that relate to rapidly changing subjects (e.g., news events, an intersection with one or more other users, or the like), may be periodically regenerated. In this way, the website may assure that the most up-to-date and highest rated content is included in a particular arena (e.g., updating the arena may prevent it from becoming stale).

FIG. 4 depicts one embodiment of an interface 400 for presenting aggregated user-submitted content. The interface 400 may be presented on a display area 110 of an application 105, which may include a navigation component 107. The interface 400 of FIG. 4 may represent an arena directed to a particular content item creation and/or authoring technique. The interface 400 may comprise an arena title 410, background description/history metadata 412, and one or more content item, submitter profile and technique/authoring description metadata sets 414 (e.g., sets 420 and 430).

The set 420 may comprise a content item 422, a submitter user profile 424, and technique/authoring description metadata 426. The content item 422 and metadata 426 may have been selected for inclusion in the arena according to a method similar to method 300 of FIG. 3 described above. The submitter user profile 424 may be a user profile of the user who submitted the content item 422 and/or the technique/authoring description metadata 426. The set 420 may comprise a rating input 428 to allow a user to rate the content item 422 and technique/authoring description metadata 426 in the context of the arena (e.g., whether the content item 422 and technique/authoring description metadata 426 is effective in the context of the arena). For example, the arena may be directed to content item authoring and/or creation techniques (e.g., stop motion animation). The rating input 428 may allow a user to indicate whether the content item 422 and associated technique/authoring description metadata 426 are effective at conveying the process used to create stop motion animation content. The rating input 428 may include a title 428A, a low-range indicator 428B, and a high-range indicator 428C.

The interface 400 may include any number of content items and metadata items. The interface 400 of FIG. 4 includes a second set 430, which comprises a content item 432, a submitter user profile 434, technique/authoring description metadata 436, and rating input 438. Although FIG. 4 depicts two sets 420 and 430, the interface 400 could include any number of content items, technique/authoring description metadata, submitter user profiles, and/or rating inputs.

The interface 400 may comprise controls 460, including a save input 460A and cancel input 460B. Selection of the save input 460A may submit the ratings entered via rating inputs 428 and 438 to the website. The ratings may be used to evaluate the contents of the interface 400 (e.g., determine whether the contents of the arena should be changed to replace a low-rated set 414 comprising a particular content item and associated technique/authoring metadata). The cancel input 460B may cause the rating inputs 428 and 438 to be cleared and not submitted to the website.

In some embodiments, the controls 460 and/or the rating inputs 428 and/or 438 may be adapted to provide a rating and/or feedback on whether a particular content item should be included in the arena. For example, a user may indicate that one or more of the content items should be removed from the arena (e.g., may indicate that the content item is irrelevant to the arena, of insufficient quality, or the like). If enough users so indicate, the content item may be removed and/or the aggregation criteria used to generate the arena may be updated accordingly (e.g., one or more thresholds may be modified, additional ratings may be included in the selection process, etc.).

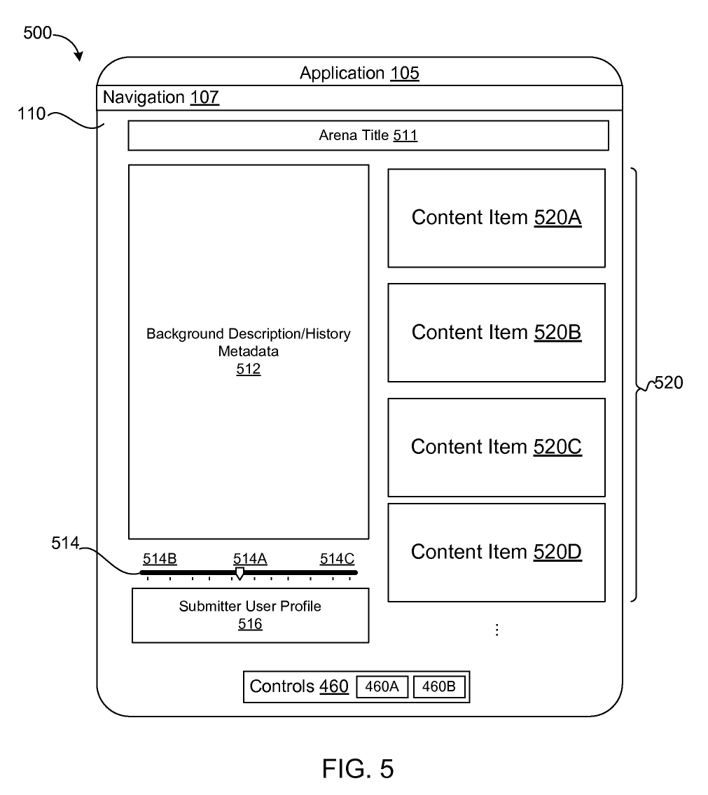

FIG. 5 depicts another embodiment of an interface 500 for presenting aggregated user-submitted content. The interface 500 may be presented on a display area 110 of an application 105. The interface 500 may comprise an arena title 511, background/description metadata 512, rating input 514, one or more content items 520, and controls 460.

The interface 500 may be used to present an arena on a particular subject area, such as a landmark (e.g., Taj Mahal, Mount Kilimanjaro, or the like), a news event, or the like. The background description/history metadata 512 may provide a description of the arena subject matter. For example, in an arena directed to the Taj Mahal, the background description/history metadata 512 may comprise a history of the Taj Mahal, its cultural significance, and the like. Alternatively, the background/history metadata 512 selected for inclusion in an arena directed to a news event may provide the details relating to the event and/or may comprise a depiction of the event (e.g., a video of a political speech, text of a debate, or the like).

The content items 520 may comprise one or more content items related to the subject area of the arena. For instance, in an arena directed to the Taj Mahal, the content items 520 may include an image of the Taj Mahal 522A, a video of the Taj Mahal 522B, and so on. In an arena directed to an event (e.g., a location, and/or a timeframe), the content items 520 may be related to the event and may include: an image of the event, a video of the event, an audio podcast related to the event, and the like. In an “intersection” arena, the content items may share related contextual metadata (e.g., time, location, subject area, or the like). Although particular types of arenas are discussed herein, the teachings of this disclosure could be adapted to generate arenas of any type comprising content items having any number of different relationships.

As discussed above, the background description/history metadata 512 and the content items 520 may be selected using a method similar to method 300 described in FIG. 3. The background description/history metadata 512 may be selected independently from the content items 520 (e.g., the background description/history metadata 512 may not be associated with any of the content items 520).

The interface 500 may include a submitter user profile 516. The submitter user profile may correspond to a user profile of the contributor of the background description/history metadata 512. In this way, the interface 500 may highlight the submitter of the background description/history metadata 512, thereby rewarding the submitter of high-quality metadata content.

The interface 500 could also be used to highlight personal description metadata (e.g., metadata entered via personal description input 135 of FIG. 1). In this embodiment, the arena may be directed to one or more personal experiences related to a topic, such as naturalism, environmentalism, or the like. In this case, the background description/history metadata 512 could be replaced with one or more personal description metadata items. The content items 520 could be selected to according to the arena topic (e.g., may comprise content having “naturalism” and/or “environmentalism” theme as indicated by metadata and/or tags associated with the content items). As discussed above, metadata and content items featured in the arena could be selected according to a method similar to method 300 described above in FIG. 3.

Although FIGS. 4 and 5 provide exemplary interfaces 400 and 500, one skilled in the art would recognize that an arena could be displayed in virtually any interface, layout, and/or any presentation method known in the art under the teachings of this disclosure including, but not limited to: a sequential slide show style interface, a video interface, an Adobe Flash® interface, or the like. As such, this disclosure should not be read as limited to any particular interface layout, technique, and/or arrangement.

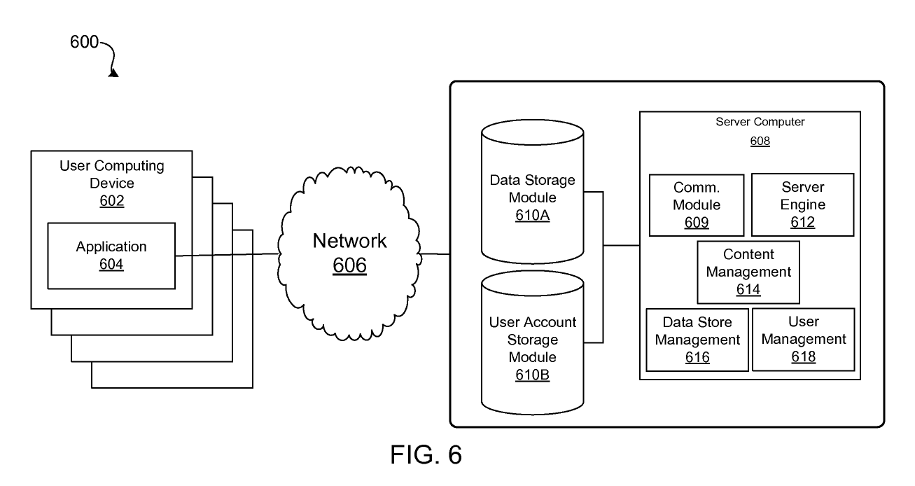

Aspects of the teachings of this disclosure may be practiced in a variety of computing environments. FIG. 6 depicts one embodiment of a system for receiving, aggregating, and presenting aggregated user-submitted content. The system 600 includes a distributed network environment comprising one or more user computing devices 602 communicatively coupled to a server computer 608 via a network 606. The server computer 608 may comprise a processor (not shown), memory (not shown), and the like. The one or more user computing devices 602 may comprise an application 604 that may be used to access and/or exchange data with other computing devices accessible via the network 606, such as a server computer 608. The application 604 may comprise a web browser, such as Microsoft Internet Explorer®, Mozilla Firefox®, Opera®, or the like. Alternatively, the application 604 may be a media player and/or content presentation software, such as Adobe Creative Suite®, Microsoft Windows Media Player®, Winamp®, or the like. The application 604 may comprise a network interface component to allow the application 604 to access content on the server computer 608 via the network 606. For example, Adobe Creative Suite® may provide access to a stock photo repository to allow users to purchase content for integration into an Adobe® project; a media player, such as Microsoft Windows Media Player®, may provide access to online, streaming music to allow a user to purchase audio content therefrom; and a web browser may provide access to web accessible content on the network 606.

The application 604 may allow a user to access websites or other content accessible via a Transmission Control Protocol (TCP)/Internet Protocol (IP) network (i.e., a TCP/IP network). One such network is the World Wide Web or Internet. One skilled in the art, however, would recognize that the teachings of this disclosure could be practiced using any networking protocol and/or infrastructure. As such, this disclosure should not be read as limited to a TCP/IP network, the Internet, or any other particular networking protocol and/or infrastructure.

The user computing devices 602 may comprise other program modules, such as an operating system, one or more application programs (e.g., word processing or spreadsheet applications), and the like. The user computing devices 602 may be general-purpose and/or specific-purpose devices that may be programmed to run various types of applications, or they may be single-purpose devices optimized or limited to a particular function or class of functions. Alternatively, the user computing devices 602 may comprise a portable computing device, such as a cellular telephone, personal digital assistant (PDA), smart phone, portable media player (e.g., Apple iPod®, multimedia jukebox device), or the like. As such, this disclosure should not be read as limited to any particular user computing device implementation and/or device interface. Accordingly, although several embodiments herein are described in conjunction with a web browser application, the use of a web browser application and a web browser interface are only used as a familiar example. As such, this disclosure should not be read as limited to any particular application implementation and/or interface.

The network 606 may comprise routing, addressing, and storage services to allow computing devices, such as the user computing devices 602 and the server computer 608 to transmit and receive data, such as web pages, text content, audio content, video content, graphic content, and/or multimedia content therebetween. The network 606 may comprise a private network and/or a virtual private network (VPN). The network 606 may comprise a client-server architecture, in which a computer, such as the server 608, is dedicated to serving the one or more user computing devices 602, or it may have other architectures, such as a peer-to-peer, in which the one or more user computing devices 602 serve simultaneously as servers and clients. In addition, although FIG. 6 depicts a single server computer 608, one skilled in the art would recognize that multiple server computers 608 could be deployed under the teachings of this disclosure (e.g., in a clustering and/or load sharing configuration). As such, this disclosure should not be read as limited to a single server computer 608.

The server computer 608 may be communicatively coupled to the network 606 by a communication module 609. The communication module 609 may comprise a wired and/or wireless network interface capable of communicating using a networking and/or communication protocol supported by the network 606 and/or the user computing devices 602.

The server 608 may comprise and/or be communicatively coupled to a data storage module 610A. The data storage module 610A may comprise one or more databases, XML data stores, file systems, X.509 directories, Light Weight Directory Access Protocol (LDAP) directories, and/or any other data storage and/or retrieval systems known in the art. The data storage module 310A may be implemented using one or more computer-readable storage media, such as hard discs, flash memory, optical storage devices, or the like. The data storage module 610A may comprise web pages and associated content to be transmitted to one or more of user computing devices 602 over network 606 (e.g., the interfaces 100, 200, 400 and/or 500 described above in connection with FIGS. 1, 2, 4, and/or 5).

The server computer 608 may comprise a server engine 612, a content page management component 614, and a data storage management module 616. The server engine 612 may perform processing and operating system level tasks including, but not limited to: managing memory access and/or persistent storage systems of server computer 608, managing connections to user computer(s) 602 over network 606, and the like. The server engine 612 may manage connections to/from user computing devices 602 using communication module 609.

The content management module 614 may create, display, and/or otherwise provide content to user computer(s) 602 over network 606. In addition, and as will be discussed below, content management component 614 may manage user account and profile information and user-submitted content, metadata and ratings displayed to or received from user computing devices 602. Data storage management module 616 may be configured to interface with the data storage module 610A to store, retrieve, and otherwise manage data in the data storage module 610A.

In one embodiment, the server engine 612 may be configured to provide data to the user computing devices 602 according to the HTTP and/or secure HTTP (HTTPS) standards. As such, the server computer 608 may provide web page content to the user computing devices 602. Although the server computer 608 is described as providing data according to the HTTP and/or HTTPS standards, one skilled in the art would recognize that any data transfer protocol and/or standard could be used under the teachings of this disclosure. As such, this disclosure should not be read as limited to any particular data transfer and/or data presentation standard and/or protocol.

The user computing devices 602 may access content stored on the data storage module 610A and made available by a content management module 614 via a URI addressing the server computer 608. The URI may comprise a domain name, which may be resolved by a domain name server (DNS) (not shown) in the network 606 into an IP address. This IP address may allow the user computing devices 602 to address and/or route content requests through the network 606 to the server computer 608. The URI may further comprise a resource identifier to identify a particular content item on the server computer 608 (e.g., content.html).

Responsive to receiving a URI request, the server engine 612 may be configured to provide the content to the user computing device 602 comprising the content (e.g., web page) identified in the URI. The content management module 614 and a data storage management module 616 may be configured to obtain and/or format the requested content to be transmitted to the user computing device 602 by the server engine 612.

Similarly, the server engine 612 may be configured to receive content submitted by a user via the one or more user computing devices 602. The user-submitted content may comprise a content item, such as an image, a video clip, audio content, or any other content item. The user-submitted content may be made available to other users via the one or more user computing devices 602 via the server computer 608.

The server computer 608 may comprise a user management module 618. The user management module 618 may access a user account data storage module 610B. The user account data storage module 610B may comprise one or more user accounts relating to one or more users authorized to access and/or submit content to the server computer 608. The user account data storage module 610B may comprise user profile information. As discussed above, a user profile may comprise a user password, content accessed by the user, content submitted by the user, ratings of the content submitted by the user, rating information submitted by the user, and the like.

The server engine 612 may be configured to display user-submitted content items and/or associated user-submitted metadata to users accessing the server 608 via the network 606. The server engine 612 may be configured to display user profile information stored in the user account data storage module 610B in conjunction with content items and/or posts submitted by a particular user.

The content management module 614 may be configured to interact with the data store management module 616 and/or the user management module 618 to generate one or more arenas comprising user-contributed content items and/or user-contributed metadata. The content management module 614 may be configured to generate one or more arenas a priori. These arenas may be selected by an administrator of the website and/or users of the website. Alternatively, or in addition, the content management module 614 may be configured to generate one or more arenas on-the-fly. These arenas may be generated in response to a user request, a user search, an inbound link to the website, or the like.

An arena may be generated using a set of aggregation criteria, which, as discussed above, may specify a topic of the arena. Aggregation criteria may include target tags (e.g., text tags), location identifiers, time identifiers, or the like. The content management module 614 may be configured to search data storage module 610A for content items and/or metadata that conforms to the aggregation criteria. As discussed above, an arena may include content items and metadata data. Accordingly, the term “item” may be used to refer to content items and/or metadata selected for inclusion in the arena.

The search may yield one or more items that are associated with metadata that conforms to the aggregation criteria. For example, the metadata associated with the item may include a text term specified in the aggregation criteria, may identify a location within a location proximity threshold of a location identified in the aggregation criteria, may identify a time within a time proximity threshold of a time identified in the aggregation criteria, or the like. In addition, the ratings of the conforming metadata may be evaluated. Relevance (or other) ratings of the conforming metadata may be compared to a metadata rating threshold, which may be defined in the aggregation criteria. If a rating of the one or more conforming metadata items is below the arena threshold, the item associated with the metadata may be removed from the aggregation (e.g., deselected). The items that have acceptably rated conforming metadata may be included in the arena.

The content management module 614 may also compare a rating of the aggregated content items and/or metadata items to one or more rating thresholds. The ratings thresholds may relate to ratings of one or more categories or aspects of the content items and/or metadata items (e.g., content item “subject appeal,” “technical merit,” or the like and/or metadata “completeness,” “descriptiveness,” “accuracy,” or the like). Content items and/or metadata having an acceptable rating may be included in the aggregation. Items that do not have an acceptably high rating (or have not been rated by enough users) may be removed from the aggregation. In some embodiments, the user rating of the submitter of a particular item may be evaluated. For instance, if a highly rated user submitted the item, the item may be included in the aggregation even if an insufficient number of users have rated the item and/or the item does not have an acceptably high rating.

The items remaining in the aggregation may be ordered according to their respective ratings. (e.g., higher rated content items and/or metadata items may be ordered higher in the third set). The order may be used in displaying the aggregation in an arena interface. For instance, higher rated items may be displayed near the top of the interface (e.g., near the top of the interfaces 400 and/or 500 described above in conjunction with FIGS. 4 and 5).

In some embodiments, the number of items and/or the number of particular types of items to be included in the aggregation may be limited. For example, a pre-determined number of video content items, a pre-determined number of image content items, and so on, may be selected for the arena depending upon the requirements of the arena (e.g., the arena may be configured to include a set number of images, text items, video, etc.). Similarly, a pre-determined number of caption metadata items, a pre-determined number of background description/history metadata items, a pre-determined number of personal description metadata items, and/or a predetermined number of technique/authoring metadata items may be selected for inclusion in the arena, again, depending upon the requirements of the arena. The items selected for inclusion may be determined according to the relative ratings of the items (e.g., in an arena limited to five items of a particular type, the top rated five items may be selected).

After the content items and/or metadata for the arena have been, the arena data may be stored in data storage module 610A. In addition, a layout may be provided for the arena. As discussed above, the arena may be laid out in a predetermined layout format, a dynamically selectable layout (e.g., a variable layout that may be modified by a viewer of the arena on-the-fly), and/or may be laid out by hand (e.g., by a user of the website, an administrator of the website, or the like). The resulting arena layout may be stored in data storage module 610A and may be made available to users through the content management module 614, the server engine 612, and/or the server computer 608.

The server computer 608, including the components thereon (e.g., content manager 614), the data storage module 610A, and the user account data storage module 610B may comprise security measures to inhibit malicious attacks thereon and to preserve integrity of the messages and data stored therein. Such measures may include, but are not limited to: firewall systems, secure socket layer (SSL) communication, user authentication, public key infrastructure (PKI) authentication, password protection schemes, data encryption, and the like.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a computer-readable medium having stored thereon instructions that may be used to program a computer (or other electronic device) to perform processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention. The scope of the present invention should, therefore, be determined only by the following claims.

We claim:

1. A computer-readable storage medium comprising instructions to cause a computing device to perform a method for aggregating content, the method comprising:
receiving aggregation criteria;
selecting one or more items from a plurality of items, wherein each of the plurality of items is associated with metadata that describes the item, wherein an item is selected if one or more metadata items associated with the item conforms to the aggregation criteria and a rating of the one or more conforming metadata items satisfies a metadata rating threshold;
aggregating the selected items; and
providing a user interface configured to display the aggregated items.

2. The computer-readable medium of claim 1, wherein the ratings of the metadata items are user-submitted ratings.

3. The computer-readable medium of claim 1, wherein the metadata associated with the items comprise one or more metadata tags, and wherein the ratings of the one or more metadata tags are user-submitted relevancy ratings.

4. The computer-readable medium of claim 1, wherein the item is selected if one or more metadata items associated with the item conforms to the aggregation criteria, a rating of the one or more conforming metadata items satisfies a metadata rating threshold, and a rating of the item satisfies an item rating threshold.

5. The computer-readable medium of claim 1, wherein the item is selected if one or more metadata items associated with the item conforms to the aggregation criteria, a rating of the one or more conforming metadata items satisfies a metadata rating threshold, and a plurality of ratings of the item satisfy the rating threshold.

6. The computer-readable medium of claim 5, wherein each of the plurality of ratings of the item corresponds to a different rating category, and wherein each of the ratings is given a respective weight.

7. The computer-readable medium of claim 1, wherein each of the plurality of items is submitted by a user having a respective user profile, each user profile comprising a user rating derived from ratings of items submitted by the user, and
wherein the item is selected based on a user rating of the submitter of the item.

8. The computer-readable medium of claim 7, wherein the item is selected if one or more of the metadata items associated with the item conform to the aggregation criteria and the item satisfies a user rating threshold.

9. The computer-readable medium of claim 1, wherein the aggregation criteria includes one or more keywords, and wherein metadata conforms to the aggregation criteria if the metadata includes one or more of the keywords.

10. The computer-readable medium of claim 1, wherein the aggregation criteria includes a location identifier, and wherein metadata conforms to the aggregation criteria if the metadata identifies a location within a location proximity threshold of the location identifier.

11. The computer-readable medium of claim 1, wherein the aggregation criteria includes a time identifier, and wherein metadata conforms to the aggregation criteria if the metadata identifies a time within a time proximity threshold of the time identifier.

12. The computer-readable medium of claim 1, wherein the aggregation criteria identifies a location and a time, and wherein metadata conforms to the aggregation criteria if the metadata identifies a location and a time within respective location and time proximity thresholds of the location identifier and the time identifier.

13. The computer-readable medium of claim 1, wherein the aggregation criteria comprises a plurality of location identifiers, each location identifier associated with a respective time identifier, and wherein metadata conforms to the aggregation criteria if the metadata identifies one of the plurality of location identifiers within a location proximity threshold and one or more of the metadata items identifies a time within a time proximity threshold of the time identifier associated with the location identifier.

14. The computer-readable medium of claim 13, wherein the plurality of location identifiers and associated time identifiers are determined from metadata associated with items submitted by one or more users.

15. The computer-readable medium of claim 1, wherein the number of content items to be included in the arena is limited to an inclusion threshold, the method further comprising selecting an inclusion threshold number of items based on user-submitted ratings of the items.

16. A method for aggregating user-submitted items, the method comprising:
receiving ratings of a plurality of user-submitted items, wherein each item is associated with metadata to describe the item;
receiving user-submitted ratings of the metadata associated with each of the plurality of items;
receiving aggregation criteria;
aggregating one or more of the user-submitted items from the plurality of user-submitted items, wherein a user-submitted item is aggregated if one or more metadata items associated with the item conforms to the aggregation criteria and ratings of one or more of the conforming metadata items satisfy a metadata rating threshold; and
providing a user interface to display the aggregated items.

17. The method of claim 16, wherein the aggregation criteria is generated responsive to a user-submitted query.

18. The method of claim 16, wherein the aggregation criteria is generated responsive to an inbound link to a website.

19. The method of claim 16, wherein the aggregation criteria is generated based on metadata associated with one or more items submitted by a user.

20. The method of claim 16, wherein the metadata rating threshold comprises a requirement that a threshold number of users have submitted a rating of the one or more conforming metadata items.

21. The method of claim 16, wherein the item is submitted by a user having user rating derived from user-submitted ratings of items submitted by the user, and
wherein the item is aggregated if the user rating of the submitter of the item satisfies a submitter threshold even if the one or more conforming metadata items associated with the item do not satisfy the metadata rating threshold.

22. The method of claim 16, wherein the ratings of the metadata are user-submitted relevancy ratings.

23. The method of claim 16, wherein the aggregation criteria comprises one or more text tags, and wherein a metadata item conforms to the aggregation criteria if the metadata item includes a portion of one or more of the text tags.

24. The method of claim 16, wherein the aggregation criteria identifies a location, and wherein a metadata item conforms to the aggregation criteria if metadata associated with the item identifies a location within a location proximity threshold of the identified location.

25. The method of claim 16, wherein the aggregation criteria identifies a location and an associated timeframe, and wherein an item is aggregated if metadata associated with the item identifies a location within a location proximity threshold of the identified location and the metadata associated with the item identifies a timeframe within a time proximity threshold of the timeframe associated with the identified location.

26. The method of claim 16, further comprising providing a user interface to display any selected one of the plurality of items to a user, wherein the user interface is configured to display the selected item with one or more metadata items associated with the item, and wherein the user interface includes one or more rating inputs configured to receive user-submitted ratings of the selected item and the one or more metadata items.

27. An apparatus for aggregating user-submitted items, comprising:
a computing device comprising a processor,
a computer-readable storage medium comprising a plurality of user-submitted items, wherein each of the items is associated with user-submitted metadata to describe the item;
a content management module communicatively coupled to the computer-readable storage medium and operable on the processor, wherein the content management module is to provide a user interface configured to display any selected one of the plurality of items, wherein the display includes one or more metadata items associated with the selected item, and wherein the display includes inputs configured to receive user-submitted ratings of the selected item and the one or more metadata items; and
a communication module operable on the processor and communicatively coupled to the computer-readable storage medium to receive user-submitted ratings of the items and to receive user-submitted ratings of metadata associated with the items;
wherein the content management module is configured to aggregate one or more of the user-submitted items based on aggregation criteria, wherein an item is aggregated if one or more metadata items associated with the item conforms to the aggregation criteria and the ratings of the one or more conforming metadata items satisfy a metadata rating threshold, and wherein the content management module is to provide for presenting the aggregated items in a user interface.

28. The apparatus of claim 27, wherein the item is aggregated if one or more metadata items associated with the item conform to the aggregation criteria and relevancy ratings of the one or more conforming metadata items satisfy the metadata rating threshold.

29. The apparatus of claim 27, wherein the item is aggregated if one or more of the metadata items associated with the item conform to the aggregation criteria, ratings of the one or more conforming metadata items satisfy the metadata rating threshold, and a rating of the item satisfies an item rating threshold.

30. The apparatus of claim 27, wherein the aggregation criteria comprises a location identifier and a time identifier, and wherein the metadata conforms to the aggregation criteria if one or more metadata items identifies a location within a location proximity threshold of the location identifier and one or more metadata items identifies a time within a time proximity threshold of the time identifier.

31. The apparatus of claim 27, wherein the aggregation criteria comprises one or more text tags, and wherein metadata conforms to the aggregation criteria if one or more metadata items includes one or more of the text tags.
